(19) United States
(12) Patent Application Publication
(10) Pub. No.: US 2021/0140643 A1
(43) Pub. Date: May 13, 2021

(54) HEATING APPARATUS

(71) Applicant: Dongzhi Xu, Dongguan, (CN)

(72) Inventor: Dongzhi Xu, Dongguan, (CN)

(21) Appl. No.: 17/155,509

(22) Filed: Jan. 22, 2021

(30) Foreign Application Priority Data
Dec. 14, 2020 (CN) 202011479545.7

(51) Int. Cl. F24C 7/00; F24H 3/04

(52) U.S. Cl. CPC F24C 7/004; F21S 10/04; F24H 3/0411

(57) ABSTRACT

A heating apparatus includes a housing, and a virtual heating module and a heating module installed inside the housing. The heating module includes at least two heating elements respectively installed on different sides of the housing, and each heating element is provided with a warm air vent facing a front side of the housing, and each heating element is in strip shape and configured at a corresponding side of the housing. The heating module is divided into several heating elements distributed at different positions of the virtual heating module to disperse the heat sources so as to increase the heating area, thereby making the user feel comfortable and warm.

### FIELD OF THE INVENTION

The present invention relates to a heating apparatus, in particular to a heating apparatus with all-sided and sufficient heating effect.

### BACKGROUND OF THE INVENTION

At present, there are many kinds of heating apparatus for warm and decoration, for example some heating apparatus simulating traditional heating tools (such as firewood, flame, coal, etc.) have been developed, which are so called virtual fireplaces. Virtual flames of the current virtual fireplaces mainly include the following ways: first, fan components combined with red flame strips and light bulbs to form a flame effect; second, LED lamp board using reflective components to project a flame shape on the projection screen, and combining fake wood or charcoal components to form 2D firewood burning flame effect; third, humidification component converting water into mist, and combining with the LED light to transmit through the fake wood or charcoal components to form 3D flame burning effect; and fourth, a naked-eye 3D displayer to simulate 3D-effect images of firewood and flames in the fireplace. Heater used in the virtual fireplaces may include infrared heating tubes, resistance wire heating, carbon fiber tubes, gas heaters, etc.

With reference to Chinese application CN201821603911.3 and Chinese application CN201920170947.5, heaters in existing virtual fireplaces are installed above or below the fireplace. But the heating area is concentrated, and the design is unreasonable and has following disadvantages: air outlet area is small, and the heating is uneven and direction of heated air is single; because the heaters are arranged horizontally, human body may feel small warming area, or only head or feet feel the warm air, which leads to uneven warming for the user's body, thus the user may not get the comfortable feeling. For this reason, the fireplace is widened and heightened, but the heating area is still insufficient, meanwhile the heating function does not match the dimensions of the product.

Therefore, there is an urgent need for providing an improved heating apparatus to solve the above-mentioned problems.

### SUMMARY OF THE INVENTION

One objective of the present invention are to provide a heating apparatus, which defines a heating module into several heating elements distributed at different positions of the virtual heating module to disperse the heat sources so as to increase the heating area, thereby making the user feel comfortable and warm.

Another objective of the present invention are to provide a heating apparatus, which configures a heating source at a side of the virtual heating module to increase the heating area, thereby making the user feel comfortable and warm.

To achieve the above objectives, the present invention provides a heating apparatus, comprising a housing, and a virtual heating module and a heating module installed inside the housing, wherein the heating module includes at least two heating elements respectively installed on different sides of the housing, and each heating element is provided with a warm air vent facing a front side of the housing, and each heating element is in strip shape and configured at a corresponding side of the housing.

Compared with the prior art, the present invention divides the heating module into multiple heating elements distributed in different positions of the virtual heating module, which not only increases the effective heating area of the heating module, but also makes the heating module heat the air uniformly. The heating speed is fast, and the heating area spreads over the upper, lower, left and right locations of the heating apparatus, so that the user can be comfortably heated in all directions, the user who locates at a farther position also can be heated. Furthermore, if the width or height of the heating apparatus is increased, the relative positions of the heating elements distributed in at least two directions of the apparatus will also change accordingly, so that the heating module matches the shape of the apparatus.

Preferably, a left or right side of the housing is provided with one said heating element, in such a way, the heating module has a sufficient heating area in the height direction, and the heating area may extend all over the human body when users stand or sit before the apparatus to warm the user. At this time, whether the other heating module is located on the right (or left), front or rear side, enough heating area can be extended in the width direction, to obtain a sufficient heating effect. On the other hand, arranging the heating elements on the left and right sides may not increase the width of the heating apparatus, thus the occupied space is saved.

Preferably, both left and right sides of the housing are respectively provided with one said heating element. In such a way, the heating elements on the left and right sides can ensure the maximum heating area in both the length direction and the width direction. When the controller and the power supply part are placed under the virtual heating module, the space of the heating elements will not be occupied by the controller and the power supply module so as to benefit the wiring.

Preferably, an upper or a lower side of the housing is provided with one said heating element.

Preferably, both upper and lower sides of the housing are respectively provided with one said heating element. In such a way, the areas of the length direction and the width direction can be heated, to the greatest extent.

Preferably, the heating apparatus further includes a controller and a power supply module, the heating module is an electric heating module, and the controller is configured to control the power supply module to supply power for the heating module and the virtual heating module, and the controller and the power supply module are installed on an upper or lower side of the housing.

Preferably, each heating element comprises a heating support, a heating unit installed on the heating support, and an air outlet assembly installed in front of the heating unit, the warm air vent is aligned with the air outlet assembly, so that heated air is blew from the warm air vent.

Preferably, the air outlet assembly further comprises an air guide grille installed on the front side of the housing, and the air guide grille is provided with a plurality of warm air channels communicated with the air guide channel, and the warm air vent is formed at an outlet of the warm air channels.

Preferably, the warm air channels are extended to lateral sides of the air outlet assembly, from back to front, to increase the air outlet area.

Preferably, the heating apparatus further includes a rotary driving part, the air guide grille is rotatably mounted on the housing along a rotating shaft longitudinally extending, and the rotary driving part drives the air guiding grille to rotate around the rotating shaft. In such a way, the air outlet area is effectively increased, especially the air outlet area perpendicular to the direction of the heating module is increased.

Preferably, the virtual heating module is fake firewood that simulates burning so that the heating apparatus is a virtual fireplace.

The present invention also provides a heating apparatus, comprising a housing, and a virtual heating module and a heating module installed in the housing, wherein the heating module includes one or more heating elements, and at least one heating element is installed on a left or right side of the housing, and the at least one heating element is in strip shape and extended along a height direction, and the at least one heating element is provided with a warm air vent facing a front side of the housing.

Compared with the prior art, since the heating element is installed on the left or right side of the virtual heating module, from top to bottom, thus the heating module has a sufficient heating area in the height direction, so that the human body can accept a larger area of heating when users stand or sit before the heating apparatus. On the other hand, arranging the heating elements on the left and right sides may not increase the width of the heating apparatus, thus the occupied space is saved.

Preferably, the heating apparatus further includes a controller and a power supply module, the heating module is an electric heating module, and the controller is configured to control the power supply module to supply power for the heating module and the virtual heating module, and the controller and the power supply module are installed on an upper or lower side of the housing. In such a way, the space of the heating elements will not be occupied by the controller and the power supply module so as to benefit the wiring.

Preferably, at least two heating elements are arranged, and two of the heating elements are respectively installed on the left and right sides of the virtual heating module.

Preferably, at least two heating elements are arranged, and one of the heating elements is installed on the upper or lower side of the virtual heating module.

Preferably, at least three heating elements are arranged, and two of the heating elements are respectively installed on the upper and lower sides of the virtual heating module.

Preferably, the heating element comprises a heating support, a heating unit installed on the heating support, and an air outlet assembly installed in front of the heating unit, the warm air vent is aligned with the air outlet assembly, so that heated air is blew from the warm air vent.

Preferably, the air outlet assembly comprises a wind wheel, a wind wheel driving part, and a wind guide channel formed on laterally opposite sides of the heating unit, the wind wheel is driven by the wind wheel driving part, and an outlet of the wind wheel is communicated with the wind guide channel to control heated air to flow along the wind guide channel at a certain rate.

Preferably, the air outlet assembly further comprises an air guide grille installed on the front side of the housing, and the air guide grille is provided with a plurality of warm air channels communicated with the air guide channel, and the warm air vent is formed at an outlet of the warm air channels.

Preferably, the warm air channels are extended to lateral sides of the air outlet assembly, from back to front.

Preferably, the heating apparatus further includes a rotary driving part, the air guide grille is rotatably mounted on the housing along a rotating shaft longitudinally extending, and the rotary driving part drives the air guiding grille to rotate around the rotating shaft.

Preferably, the virtual heating module is fake firewood that simulates burning so that the heating apparatus is a virtual fireplace.

### BRIEF DESCRIPTION OF THE DRAWINGS

The accompanying drawings facilitate an understanding of the various embodiments of this invention. In such drawings:

FIG. 1 is a perspective view of a heating apparatus that is turned off according to a first embodiment of the present invention;

FIG. 2 is a front view of a heating apparatus that is turned off according to a first embodiment of the present invention;

FIG. 3a is a cross-sectional view taken along line A-A in FIG. 2;

FIG. 3b is a cross-sectional view taken along line B-B in FIG. 2;

FIG. 3c is a cross-sectional view taken along line C-C in FIG. 2;

FIG. 3d is a schematic view of the heating element of the heating apparatus;

FIG. 4a is a front view of a heating apparatus blowing warm air from the warm air vents according to the first embodiment of the present invention;

FIG. 4b is a side view of a heating apparatus blowing warm air from the warm air vents according to the first embodiment of the present invention;

FIG. 4c is a top and cross-sectional view of a heating apparatus blowing warm air from the warm air vents according to the first embodiment of the present invention;

FIG. 4d is a perspective view of a heating apparatus blowing warm air from the warm air vents according to the first embodiment of the present invention;

FIG. 5a is a front view of a heating apparatus according to a second embodiment of the present invention;

FIG. 5b is a front view of a heating apparatus according to a third embodiment of the present invention;

FIG. 5c is a front view of a heating apparatus according to a fourth embodiment of the present invention;

FIG. 5d is a front view of a heating apparatus according to a fifth embodiment of the present invention;

FIG. 5e is a front view of a heating apparatus according to a sixth embodiment of the present invention;

FIG. 5f is a front view of a heating apparatus according to a seventh embodiment of the present invention;

FIG. 5g is a front view of a heating apparatus according to an eighth embodiment of the present invention;

FIG. 5h is a front view of a heating apparatus according to a ninth embodiment of the present invention;

FIG. 6 is a front view of a heating apparatus according to a tenth embodiment of the present invention; and

FIG. 7 is a front view of a heating apparatus according to an eleventh embodiment of the present invention.

### DETAILED DESCRIPTION OF ILLUSTRATED EMBODIMENTS

A distinct and full description of the technical solution of the present invention will follow by combining with the accompanying drawings.

Referring to FIGS. 1-2, the present invention provides a heating apparatus 100 including a housing 10, and a virtual heating module 20 and a heating module 30 installed inside the housing 10. The heating module 30 includes two heating elements 31 respectively installed on different sides of the housing 10, namely located at different sides of the virtual heating module 20, and each heating element 31 or 32 is provided with a warm air vent 304 facing a front side of the housing 10, and each heating element 31 or 32 is in strip shape and configured at a corresponding side of the housing 20.

Specifically, the housing 10 has opposite left side and right side, opposite upper side and lower side. The heating element 31 is configured at the left side of the housing 20 and arranged in a height direction of the housing 20, and the heating element 32 is configured at the right side of the housing 20 and arranged in the height direction of the housing 20. More specifically, the heating elements 31, 32 can be extended along a vertical direction, or at a certain angle to the vertical direction (such as an angle <40° or <30°), or along a wavy line extending in the height direction, etc.

Referring to FIG. 3c, the heating apparatus 100 further includes a controller 51 and a power supply module 52. The heating module 30 is an electric heating module, and the controller 51 is configured to control the power supply module 52 to supply power to the heating module 30 and the virtual heating module 20. Referring to FIGS. 1 and 2, the heating apparatus 100 further includes an information interaction panel 11 for inputting control signals and displaying the current status of the heating apparatus 100. In this embodiment, the information interaction panel 11 is installed on the top of the front side of heating apparatus 100, for easy control. Responding to the commands input by the information interaction panel 11, the controller 51 controls the actions of the virtual heating module 20 and the heating module 10, and controls a display screen or an indicator light in the information interaction panel 11 to display the current working status.

Referring to FIG. 3c, in order to facilitate wiring, the controller 51 and the power supply module 52 are installed in an installation cavity located at the lower side of the virtual heating module 20. In order to facilitate installation and isolation, the housing 10 provides a first cavity for accommodating the virtual heating module 20, a second cavity for accommodating the heating elements 31/32, and a third cavity for accommodating the controller 51 and the power supply module 52.

Specifically, the virtual heating module 20 is imitated burning firewood, so that the heating apparatus 100 is a virtual fireplace. Of course, the virtual heating module can also be other virtual modules, such as virtual images/screen/lights for displaying virtual coal stoves, fires or volcanoes etc. Referring to FIGS. 1, 3a and 3c, in this embodiment, the virtual heating module 20 includes an imitated firewood 21, a plate 22 installed in the imitated firewood 21, and a spiral reflective blade 23 and a LED light bar 24 installed in the plate 22. The LED light bar 24 irradiates light to the plate 22 through the spiral reflective blade 23, so that the light becomes a flame and passes through the imitated firewood 21 and is projected onto the imitated firewood 21 to simulate the flame of firewood (as shown in FIG. 2).

Referring to FIGS. 1, 3b and 3d, the heating element 31 or 32 includes a heating support 301, a heating unit 302 installed on the heating support 301, and an air outlet assembly 303 installed in front of the heating unit 302, the warm air vent 304 is aligned with the air outlet assembly 303, so that the heated air can be blew from the warm air vent 304. In this embodiment, the warm air vent 304 is an air outlet, and an air inlet 305 is located at a corresponding position on the side and/or back of the housing 10. The structure of the heating elements 31 and 32 are similar, which will not be repeated here therefore. The heating element 31 or 32 may further include a temperature monitor 306 installed on the heating support 301 to detect the heating temperature of the heating unit 302. The controller 51 is connected to the temperature monitor 306 to control the heating unit 302 to stop heating when the heating temperature exceeds a preset value.

Referring to FIG. 1, the air outlet assembly 303 includes a wind wheel 41, a wind wheel driving part 42 for driving the wind wheel 41, and an air guide channel 43 formed on two laterally opposite sides of the heating unit 302. The wind wheel 41 is driven by the wind wheel driving part 42, and an outlet of the wind wheel 41 is communicated with the wind guide channel 43 to control the heated air to flow along the wind guide channel 43 at a certain rate. In this embodiment, the wind wheel driving part 42 is a fan motor. The air guiding channel 43 is formed on the heating support 301.

Preferably, the air guide channel 43 includes an inclined section (as shown in FIG. 3a), so as to increase the air guide channel, by comparison with a horizontal channel. In such a way, the heating efficiency of the heating unit is improved, and the air is more stable.

Referring to FIGS. 1, 3a, 3b and 3d, the air outlet assembly 303 further includes an air guide grill 44 installed on the front side of the housing 10, and the air guide grill 44 is provided with a warm air channel 45 communicated with the air guide channel. The warm air outlet 304 is formed at the outlet of the warm air channel 45. Specifically, the air guide grill 44 includes a protective plate located on the outside of the heating unit 302 and a wind deflector plate located on the outside of the protective plate. More specifically, the protective plate is provided with a plurality of through holes arranged transversely along the heating element, and the wind deflector plate is provided with a plurality of air guide holes arranged in the longitudinal direction of the heating element, and the width of the through holes is smaller than the width of a human finger to prevent the human hand from reaching in.

Referring to FIGS. 4a to 4d, which are schematic diagrams of the heating apparatus 100 showing the warm air flow in the first embodiment. The arrow indicates the warm air flow. It can be seen that, the air from the warm air vent 304 flows to both sides and the upper side, so that the heating air are joined in the middle of the heating apparatus 100, so that an all-around heating can be achieved (as shown in FIG. 4d).

Referring to FIG. 5a, a heating apparatus according to a second embodiment is shown, different from the first one, three heating elements are arranged in the present embodiment. Specifically, a left heating element 31 is arranged at a left side of the virtual heating module 20, a right heating element 32 is arranged at a right side of the virtual heating module 20, and an upper heating element 33 is arranged at the upper side of the virtual heating module 20. Each heating element 31/32/33 is in strip shape and extended at its corresponding side.

Specifically, the upper heating element 33 is configured at the upper side of the housing 20 and arranged in a width direction (horizontal direction) of the housing 20. More specifically, the heating element 33 can be extended along a horizontal direction, or at a certain angle to the horizontal direction (such as an angle <40° or <30°), or along a wavy line extending in the horizontal direction, etc.

Referring to FIG. 5b, a heating apparatus according to a third embodiment is shown, different from the first one, three heating elements are arranged in the present embodiment. Specifically, a left heating element 31 is arranged at a left side of the virtual heating module 20, a right heating element 32 is arranged at a right side of the virtual heating module 20, and a lower heating element 34 is arranged at the lower side of the virtual heating module 20. Each heating element 31/32/34 is in strip shape and extended at its corresponding side.

Specifically, the lower heating element 34 is configured at the lower side of the housing 20 and arranged in a width direction (horizontal direction) of the housing 20. More specifically, the heating element 34 can be extended along a horizontal direction, or at a certain angle to the horizontal direction (such as an angle <40° or <30°), or along a wavy line extending in the horizontal direction, etc.

Referring to FIG. 5c, a heating apparatus according to a fourth embodiment is shown, different from the first one, four heating elements are arranged in the present embodiment. Specifically, a left heating element 31 is arranged at a left side of the virtual heating module 20, a right heating element 32 is arranged at a right side of the virtual heating module 20, an upper heating element 33 is arranged at a upper side or the virtual heating module 20, and a lower heating element 34 is arranged at the lower side of the virtual heating module 20. Each heating element 31/32/33/34 is in strip shape and extended at its corresponding side.

Specifically, the upper heating element 33 is configured at the upper side of the housing 20 and arranged in a width direction (horizontal direction) of the housing 20, and the lower heating element 34 is configured at the lower side of the housing 20 and arranged in a width direction (horizontal direction) of the housing 20. More specifically, the heating elements 33 and 34 can be extended along the horizontal direction, or at a certain angle to the horizontal direction (such as an angle <40° or <30°), or along a wavy line extending in the horizontal direction, etc.

Referring to FIG. 5d, a heating apparatus according to a fifth embodiment is shown, different from the first one, two heating elements are arranged in the present embodiment. Specifically, an upper heating element 33 is arranged at an upper side or the virtual heating module 20, and a lower heating element 34 is arranged at the lower side of the virtual heating module 20. Each heating element 33/34 is in strip shape and extended at its corresponding side.

Specifically, the upper heating element 33 is configured at the upper side of the housing 20 and arranged in a width direction (horizontal direction) of the housing 20, and the lower heating element 34 is configured at the lower side of the housing 20 and arranged in a width direction (horizontal direction) of the housing 20. More specifically, the heating elements 33 and 34 can be extended along the horizontal direction, or at a certain angle to the horizontal direction (such as an angle <40° or <30°), or along a wavy line extending in the horizontal direction, etc.

Referring to FIG. 5e, a heating apparatus according to a sixth embodiment is shown, different from the first one, two heating elements are arranged in the present embodiment. Specifically, a right heating element 32 is arranged at the right side or the virtual heating module 20, and an upper heating element 33 is arranged at the upper side of the virtual heating module 20. Each heating element 32/33 is in strip shape and extended at its corresponding side.

Specifically, the upper heating element 33 is configured at the upper side of the housing 20 and arranged in a width direction (horizontal direction) of the housing 20. More specifically, the heating elements 33 can be extended along the horizontal direction, or at a certain angle to the horizontal direction (such as an angle <40° or <30°), or along a wavy line extending in the horizontal direction, etc.

Referring to FIG. 5f, a heating apparatus according to a seventh embodiment is shown, different from the first one, two heating elements are arranged in the present embodiment. Specifically, a left heating element 31 is arranged at the left side or the virtual heating module 20, and an upper heating element 33 is arranged at the upper side of the virtual heating module 20. Each heating element 31/33 is in strip shape and extended at its corresponding side.

Specifically, the upper heating element 33 is configured at the upper side of the housing 20 and arranged in a width direction (horizontal direction) of the housing 20. More specifically, the upper heating element 33 can be extended along the horizontal direction, or at a certain angle to the horizontal direction (such as an angle <40° or <30°), or along a wavy line extending in the horizontal direction, etc.

Referring to FIG. 5g, a heating apparatus according to an eighth embodiment is shown, different from the first one, two heating elements are arranged in the present embodiment. Specifically, a left heating element 31 is arranged at the left side or the virtual heating module 20, and a lower heating element 34 is arranged at the lower side of the virtual heating module 20. Each heating element 31/34 is in strip shape and extended at its corresponding side.

Specifically, the lower heating element 34 is configured at the lower side of the housing 20 and arranged in a width direction (horizontal direction) of the housing 20. More specifically, the lower heating element 34 can be extended along the horizontal direction, or at a certain angle to the horizontal direction (such as an angle <40° or <30°), or along a wavy line extending in the horizontal direction, etc.

Referring to FIG. 5h, a heating apparatus according to a ninth embodiment is shown, different from the first one, two heating elements are arranged in the present embodiment. Specifically, a right heating element 32 is arranged at the left side or the virtual heating module 20, and a lower heating element 34 is arranged at the lower side of the virtual heating module 20. Each heating element 32/34 is in strip shape and extended at its corresponding side.

Specifically, the lower heating element 34 is configured at the lower side of the housing 20 and arranged in a width direction (horizontal direction) of the housing 20. More specifically, the lower heating element 34 can be extended along the horizontal direction, or at a certain angle to the horizontal direction (such as an angle <40° or <30°), or along a wavy line extending in the horizontal direction, etc.

Referring to FIG. 6, a heating apparatus according to a tenth embodiment is shown, different from the first one, only one heating element is arranged in the present embodiment. Specifically, a left heating element 31 is arranged at the left side or the virtual heating module 20, and the left heating element 31 is in strip shape and extended at the height direction.

Specifically, the left heating element 31 can be extended along the height (vertical) direction, or at a certain angle to the vertical direction (such as an angle <40° or <30°), or along a wavy line extending in the horizontal direction,

Preferably, the left heating element 31 can be arranged all over the left side of the heating apparatus 100, and the information interaction panel 11 can be arranged at the right side.

Referring to FIG. 7, a heating apparatus according to an eleventh embodiment is shown, different from the first one, only one heating element is arranged in the present embodiment. Specifically, a right heating element 31 is arranged at the right side of the virtual heating module 20, and the right heating element 32 is in strip shape and extended at the height direction.

Specifically, the right heating element 32 can be extended along the height (vertical) direction, or at a certain angle to the vertical direction (such as an angle <40° or <30°), or along a wavy line extending in the horizontal direction,

Preferably, the right heating element 32 can be arranged all over the right side of the heating apparatus 100, and the information interaction panel 11 can be arranged at the left side.

In the above-mentioned embodiment, the heating element 31/32/33/34 can cover the whole corresponding side, or cover most of the area of the corresponding side, or only cover the middle position of the corresponding side, which depends on the size of the heating element and the length and width of the corresponding side.

In the above-mentioned embodiments, the heating apparatus is a movable device, of course, has other forms such as a wall-mounted fixed heater or a built-in heater embedded in a wall.

The heating unit in the present invention is an electric heater, including: infrared heating tube, resistance wire heating, carbon fiber tube, ceramic heating element, etc., of course, it can also be a heater with other structures.

Based on the above-mentioned embodiments, in a preferred embodiment, the warm air channels 45 are extended to lateral sides of the air outlet assembly 30, from back to front, so as to increase the air outlet area (not shown).

In another preferred embodiment, the heating apparatus 100 further includes a rotary driving part (not shown), the air guide grille 44 is rotatably mounted on the housing 10 along a rotating shaft longitudinally extending, and the rotary driving part drives the air guiding grille 44 to rotate around the rotating shaft, so that the air guiding grill 44 can guide wind laterally (not shown).

While the invention has been described in connection with what are presently considered to be the most practical and preferred embodiments, it is to be understood that the invention is not to be limited to the disclosed embodiments, but on the contrary, is intended to cover various modifications and equivalent arrangement included within the spirit and scope of the invention.

What is claimed is:

1. A heating apparatus, comprising a housing, and a virtual heating module and a heating module installed inside the housing, wherein the heating module includes at least two heating elements respectively installed on different sides of the housing, and each heating element is provided with a warm air vent facing a front side of the housing, and each heating element is in strip shape and configured at a corresponding side of the housing.

2. The heating apparatus as claimed in claim 1, wherein a left or right side of the housing is provided with one said heating element, or both left and right sides of the housing are respectively provided with one said heating element.

3. The heating apparatus as claimed in claim 1, wherein an upper or a lower side of the housing is provided with one said heating element, or both upper and lower sides of the housing are respectively provided with one said heating element.

4. The heating apparatus as claimed in claim 1, wherein each heating element comprises a heating support, a heating unit installed on the heating support, and an air outlet assembly installed in front of the heating unit, the warm air vent is aligned with the air outlet assembly, so that heated air is blew from the warm air vent.

5. The heating apparatus as claimed in claim 4, wherein the air outlet assembly comprises a wind wheel, a wind wheel driving part, and a wind guide channel formed on laterally opposite sides of the heating unit, the wind wheel is driven by the wind wheel driving part, and an outlet of the wind wheel is communicated with the wind guide channel to control heated air to flow along the wind guide channel at a certain rate.

6. The heating apparatus as claimed in claim 5, wherein the air guide channel comprises an inclined section inclined toward outside of the heating apparatus.

7. The heating apparatus as claimed in claim 5, wherein the air outlet assembly further comprises an air guide grille installed on the front side of the housing, and the air guide grille is provided with a plurality of warm air channels communicated with the air guide channel, and the warm air vent is formed at an outlet of the warm air channels.

8. The heating apparatus as claimed in claim 6, wherein the warm air channels are extended to lateral sides of the air outlet assembly, from back to front.

9. The heating apparatus as claimed in claim 6, further comprising a rotary driving part, the air guide grille is rotatably mounted on the housing along a rotating shaft longitudinally extending, and the rotary driving part drives the air guiding grille to rotate around the rotating shaft.

10. The heating apparatus of claim 1, wherein the virtual heating module is fake firewood that simulates burning so that the heating apparatus is a virtual fireplace.

11. A heating apparatus, comprising a housing, and a virtual heating module and a heating module installed in the housing, wherein the heating module includes one or more heating elements, and at least one heating element is installed on a left or right side of the housing, and the at least one heating element is in strip shape and extended along a height direction, and the at least one heating element is provided with a warm air vent facing a front side of the housing.

12. The heating apparatus as claimed in claim 11, further comprising a controller and a power supply module, the heating module is an electric heating module, and the controller is configured to control the power supply module to supply power for the heating module and the virtual heating module, and the controller and the power supply module are installed on an upper or lower side of the housing.

13. The heating apparatus as claimed in claim 11, wherein the heating element comprises a heating support, a heating unit installed on the heating support, and an air outlet assembly installed in front of the heating unit, the warm air vent is aligned with the air outlet assembly, so that heated air is blew from the warm air vent.

14. The heating apparatus as claimed in claim 13, wherein the air outlet assembly comprises a wind wheel, a wind wheel driving part, and a wind guide channel formed on laterally opposite sides of the heating unit, the wind wheel is driven by the wind wheel driving part, and an outlet of the wind wheel is communicated with the wind guide channel to control heated air to flow along the wind guide channel at a certain rate.

15. The heating apparatus as claimed in claim 14, wherein the air guide channel comprises an inclined section inclined toward outside of the heating apparatus.

16. The heating apparatus as claimed in claim 14, wherein the air outlet assembly further comprises an air guide grille installed on the front side of the housing, and the air guide grille is provided with a plurality of warm air channels communicated with the air guide channel, and the warm air vent is formed at an outlet of the warm air channels.

17. The heating apparatus as claimed in claim 14, wherein the warm air channels are extended to lateral sides of the air outlet assembly, from back to front.

18. The heating apparatus as claimed in claim 14, further comprising a rotary driving part, the air guide grille is rotatably mounted on the housing along a rotating shaft longitudinally extending, and the rotary driving part drives the air guiding grille to rotate around the rotating shaft.

19. The heating apparatus as claimed in claim 11, wherein the virtual heating module is fake firewood that simulates burning so that the heating apparatus is a virtual fireplace.
